(19) United States
(12) Patent Application Publication
(10) Pub. No.: US 2026/0365932 A1
(43) Pub. Date: Nov. 19, 2026

(54) A METHOD FOR PRODUCING SYNGAS USING CATALYTIC REVERSE WATER GAS SHIFT

(71) Applicant: SHELL USA, INC., Houston, TX (US)

(72) Inventors: Ronald Jan SCHOONEBEEK, Castricum (NL); Alouisius Nicolaas Renée BOS, Amsterdam (NL); Dominik Johannes Michael UNRUH, Amsterdam (NL)

(21) Appl. No.: 19/475,905

(22) PCT Filed: May 7, 2024
(86) PCT No.: PCT/EP2024/062580

§ 371 Date: Oct. 16, 2025

(30) Foreign Application Priority Data
May 16, 2023 (EP) 23173572.1

(51) Int. Cl. C10K 3/02; B01J 8/06

(52) U.S. Cl. CPC C10K 3/026; B01J 8/067; B01J 2208/065

(57) ABSTRACT

The present invention relates to a method for producing syngas using a catalytic reverse water gas shift (RWGS) reaction, the method at least comprising the steps of: a) providing a feed stream (10) comprising at least hydrogen (H2) and carbon dioxide (CO2); b) introducing the feed stream (10) provided in step a) into a RWGS reactor (2) and subjecting it to a catalytic RWGS reaction, thereby obtaining a syngas containing stream (20); wherein the RWGS reactor (2) comprises a multitubular reactor heated by molten salt circulating around the tubes (5) of the multi-tubular reactor, preferably in counter-current operation; wherein the molten salt comprises a carbonate salt; and wherein during the RWGS reaction in step b) the molten salt is purged with a CO2-containing gas, preferably with a flux of at least 0.01 g/h/t (gram per hour per ton (1000 kg)) carbonates in the RWGS reactor (2).

The present invention relates to a method for producing syngas using a catalytic reverse water gas shift (RWGS) reaction.

Methods for producing syngas using RWGS are known.

RWGS reactions convert carbon dioxide (CO₂) and hydrogen (H₂) into ‘syngas’, which contains at least carbon monoxide (CO) and hydrogen (H₂). RWGS reactions are endothermic in nature; hence, it is necessary to supply sufficient thermal energy to the reactants (i.e. carbon dioxide and hydrogen) to facilitate the endothermic RWGS reaction.

The RWGS reaction is in fact the backward reaction of the equilibrium of the ‘water gas shift’ (WGS) reaction, which is a well-known reaction to convert carbon monoxide and water to carbon dioxide and hydrogen. The RWGS reaction can proceed without the use of a catalyst, but this requires very high temperatures (e.g. 1000 °C or even much higher) favoring both the kinetics and maximum achievable equilibrium conversions.

If a catalyst for the RWGS reaction is used, much lower temperatures can be applied for the reaction to proceed and the reaction conditions, reactor wall materials and catalyst used at commercial scale are to be selected such that the catalyzation of the very exothermic methanation reaction (CO₂+4H₂->CH₄+2H₂O) is avoided or at least minimized. The thermodynamics may drive the reaction towards methanation (rather than towards RWGS) and too low temperatures may severely lower the equilibrium conversion of RWGS itself, so finding reaction conditions and a catalyst resulting in acceptable conversion of CO₂ to syngas with non-methanation or very low methanation is a key challenge.

Currently, the status of developments regarding the RWGS reaction have been mostly on lab-scale. There is still a lot to explore until large-scale RWGS will be a commercially attractive option.

For large-scale conversion of carbon dioxide there is a need to be able to more efficiently and economically carry out the RWGS reaction. In achieving high conversion of carbon dioxide selectively to carbon monoxide, by-products like methane and carbon formation are to be avoided. Also, the amount of energy input required for performing the endothermic RWGS reaction requires attention.

As a mere example of a recently published RWGS method, WO2022263384A1 discloses a method for producing syngas using a catalytic RWGS reaction. In one of the embodiments of WO2022263384A1, it is suggested that the RWGS reactor comprises a multi-tubular reactor heated by molten salt circulating around the tubes of the multi-tubular reactor. The molten salt used has not been specified.

In the art, typically nitrate-containing salts (such as mixtures of nitrate and nitrite and in particular mixtures of potassium nitrate and sodium nitrate) have been suggested as the molten salt of choice because of their relatively low melting point (typically below 240 °C) and good stability up to around 550 °C. See for example the article “Thermostatic properties of nitrate molten salts and their solar and eutectic mixtures” by D'Aguanno et al., Scientific Reports (2018) 8: 10485. DOI: 10.1038/s41598-018-28641-1. The thermal stability of such nitrate-containing salts is usually further supported by oxygen purge (e.g. air) over the molten salt (thereby reacting thermal degradation products back into nitrates).

The inventors have now discovered that such nitrate-containing salts may result in serious operational and safety issues when the RWGS reactor comprises a multi-tubular reactor heated by molten nitrate salts selected on the basis of operating temperatures and other criteria such as stability, toxicity, cost etc.

Firstly, due to relatively high partial H₂ pressures (typically >10 bara) and medium to high temperatures (>450 °C) in the RWGS reaction, some hydrogen (H₂) may diffuse through the tube walls of the multi-tubular reactor and into the molten salt. At the operating (molten salts) temperatures in the RWGS reactor, and after hydrogen diffusion has taken place, the H₂ may subsequently react with the nitrate salt thereby reducing the nitrate salts into nitrite salts and water (e.g. KNO₃+H₂->KNO₂+H₂O). Nitrite salts are thermally less stable and may decompose faster into NOₓ and insoluble oxides. This salts degradation may require costly replenishing of the molten salts. Furthermore, the NOx as well as any unreacted H₂ would need to be removed from the normally closed salts circulation system; as NO₂ and H₂O are very corrosive if condensation thereof occurs, this could lead to severe damages to e.g. the exhaust system. The H₂ itself could cause a severe safety hazard because explosive mixtures of H₂ and O₂ may be generated.

Besides the diffusion of hydrogen through the reactor walls, hydrogen may also end up into the salts circulation system as result of e.g. a leaking welding of one of the tubes or by a calamity (tube rupture) which can also lead to similar reactions and consequences.

It is an object of the present invention to minimize one or more of the above problems.

It is a further object of the present invention to provide a method for producing syngas using a catalytic RWGS reaction wherein the RWGS reactor comprises a multi-tubular reactor heated by molten salt, and wherein a safe and stable molten salt is used as a heating fluid.

It is an even further object to provide an alternative method for producing syngas using a catalytic RWGS reaction minimizing the thermodynamically favored formation of methane.

One or more of the above or other objects can be achieved by providing a method for producing syngas using a catalytic reverse water gas shift (RWGS) reaction, the method at least comprising the steps of:
a) providing a feed stream comprising at least hydrogen (H₂) and carbon dioxide (CO₂);
b) introducing the feed stream provided in step a) into a RWGS reactor and subjecting it to a catalytic RWGS reaction, thereby obtaining a syngas containing stream;

wherein the RWGS reactor comprises a multi-tubular reactor heated by molten salt circulating around the tubes of the multi-tubular reactor, preferably in counter-current operation; and

wherein the molten salt comprises a carbonate salt; and

wherein during the RWGS reaction in step b) the molten salt is purged with a CO₂-containing gas, preferably with a flux of at least 0.01 g/h/t (gram per hour per ton (1000 kg) ) carbonates in the RWGS reactor.

It has surprisingly been found according to the present invention that by using carbonate salts as the molten salt a more stable and safer operation of the multi-tubular RWGS reactor with heating by molten salts can be achieved. Even if hydrogen diffusion would occur, this will not have the same impact (as mentioned above) as when a nitrate or nitrite salt is used as the molten salt.

In this respect it is noted that the article by T. Kodama et al., “CO₂ reforming of Methane in a Molten Carbonate Salt Bath for Use in Solar Thermochemical Processes”, in Energy & Fuels 2001, 15 60-65 and the article by N. Gokon et al., “Double-walled reformer tubes using high-temperature thermal storage of molten-salt/MgO composite for solar cavity-type reformer”, in International Journal of Hydrogen Energy 34(2009 ), 7143-7154 mention the use of carbonate salts, but not for use in RWGS.

In step a) of the method according to the present invention a feed stream is provided comprising at least hydrogen (H₂) and carbon dioxide (CO₂). The person skilled in the art will readily understand that the feed stream is not particularly limited and may come from various sources. The feed stream may originate from a separate process and be provided as such or may be combined using different streams. As mere examples of the latter: the CO₂ in the feed stream may originate from a DAC (Direct Air Capture) unit or other removal units, whilst the hydrogen in the feed stream may originate from H₂O electrolysis.

The feed stream may have been pre-processed to obtain the desired composition and conditions (which may be dependent on the subsequent use of the syngas containing stream as obtained in step b)).

The catalytic RWGS reaction in step b) can be performed as a single stage RWGS reaction (as e.g. disclosed in WO2022263384A1) or as a multistage RWGS reaction (as e.g. disclosed in WO2022129338A1) and also with or without a CO₂ removal and recycle step. Therefore, the composition of the feed stream to the RWGS reactor may vary widely and will depend significantly on the specific line-up and on the position of the specific RWGS reactor in said line-up.

Typically, the feed stream provided in step a) (and introduced into the RWGS reactor in step b) ) comprises 40-90 vol. % H₂, preferably 45-75 vol. % H₂, and typically 10-60 vol. % CO₂, preferably 25-55 vol. % CO₂. Other components such as CH₄, CO, H₂O, C2+, C=2+ (i.e. olefins containing 2 or more carbon atoms), N₂, Ar, O₂, sulphur components (such as H₂S, mercaptans, COS, SO₂) and nitrogen compounds (such as NOₓ, NH₃) may be present. Also, the feed stream may contain small amounts of sorbent (such as amines, KOH, MeOH, glycols, etc.), e.g. as used in DAC [Direct Air Capture] ) or other CO₂ removal units.

Preferably, dependent on the specific line-up and on the position of the specific RWGS reactor in said line-up as well as the desired H₂/CO ratio of the eventual syngas product, the feed stream provided in step a) has a hydrogen to carbon dioxide (H₂/CO₂) volume ratio of from 0.7 to 9.0, preferably below 3.0, and preferably above 0.8. The H₂/CO₂ volume ratio of hydrogen to carbon dioxide can be adjusted such that the required hydrogen to carbon monoxide ratio in the eventual product stream is obtained.

Generally, the feed stream provided in step a) has a temperature of 200-700 °C, preferably 450-600 °C. The feed stream provided in step a) typically has a pressure in the range of from 1 to 200 bara. Preferably, the pressure is from 5 to 70 bara.

In step b) of the method according to the present invention, the feed stream provided in step a) is introduced into a RWGS reactor and subjected to a catalytic RWGS reaction, thereby obtaining a syngas containing stream.

As the person skilled in the art is familiar with RWGS reactors and conditions of catalytic RWGS reactions, this is not discussed here in detail.

Typical temperatures of the catalytic RWGS reaction in the RWGS reactor are 450-700 °C, preferably above 500 °C. The person skilled in the art will understand that the temperature may vary over the reactor (e.g. higher at the inlet than at the outlet, in particular for an adiabatic process). Preferably, the outlet temperature of the catalytic RWGS reaction in step b) is kept below 700 °C, preferably below 600 °C.

As, the RWGS reaction is endothermic, heating needs to be provided to the reactor.

According to the present invention, the RWGS reactor comprises a multi-tubular reactor heated at least in part by molten salt circulating around the tubes of the multi-tubular reactor, preferably in counter-current operation. However, although not preferred, additional heating may be present. The multi-tubular reactor comprises a plurality of tubes, wherein each tube comprises catalyst (e.g. in the form of a catalyst bed).

Preferably, the reactor walls of the tubes of the multi-tubular reactor are made from a material that possesses good resistance to corrosive attack under the process conditions (e.g. the presence of hot synthesis gas). Further, it is preferred that the tubes of the multi-tubular reactor are made from a material that have a low hydrogen porosity (to reduce hydrogen diffusion). Suitable materials are for example austenitic materials, such as nickel-based alloys that contain a passive chromium oxide surface.

Typical pressures as used in the RWGS reactor are 1-200 bara, preferably above 20 bara and preferably below 70 bara. Further, typical gas hourly space velocities (GHSV) are 500-100, 000 Nm³m³h⁻¹ (or simply denoted as) h⁻¹), preferably above 3,000 h⁻¹ and preferably below 10,000 h⁻¹.

In the multi-tubular RWGS reactor a catalytic RWGS reaction takes place and this requires the presence of a catalyst. Typically, the multi-tubular RWGS reactor comprises thousand or even tens of thousands of relatively small tubes (e.g. 1-4 inch in diameter), wherein each tube contains a catalyst bed. As the person skilled in the art is familiar with multi-tubular reactors and suitable RWGS catalysts, this is not discussed here in detail. Preferably, the catalyst bed comprises a catalyst that is suitable for performing the RWGS reaction below 700 °C. Further it is preferred that the catalyst does not promote methanation under the used conditions. Preferred examples of suitable ‘non-methanation promoting’ catalysts comprise at least cerium oxide, zirconium oxide, or a combination thereof. Hence, preferably, the RWGS reactor comprises a non-methanation promoting catalyst, preferably comprising at least cerium oxide, zirconium oxide or a combination thereof. The catalyst may contain further components in addition to the cerium oxide and/or zirconium oxide.

As mentioned above, according to the present invention, the RWGS reactor comprises a multi-tubular reactor heated by molten salt circulating around the tubes of the multi-tubular reactor. The molten salt provides for the heat required for the endothermic reaction as taking place in the multi-tubular reactor. Preferably, the molten salt is circulating in counter-current mode around the tubes of the multi-tubular reactor (when compared to the fluid flow in the tubes of the reactor). The circulating molten salt is preferably heated outside the reactor, preferably using electrical heating in a separate salts vessel. Preferably, each of the tubes of the multi-tubular reactor comprises a catalyst.

The catalytic RWGS reaction can be performed as a single stage RWGS reaction (as e.g. disclosed in WO2022263384A1) or as a multistage RWGS reaction (as e.g. disclosed in WO2022129338A1).

As mentioned above, the molten salt as used in the method according to the present invention comprises a carbonate salt. Preferably the molten salt as used in the method according to the present invention comprises a eutectic mixture of two or more carbonate salts.

Preferably, the molten salt comprises at least 90 wt. % carbonate salt, based on the total weight of the molten salt.

Further it is preferred that the carbonate salt is selected from the group consisting of sodium carbonate, lithium carbonate and potassium carbonate and mixtures thereof. Preferably, the molten salt comprises a mixture of lithium carbonate and one or both of sodium carbonate and potassium carbonate thereby forming a eutectic mixture (i.e. a homogeneous mixture that has a melting point that is lower than the melting point of the individual constituents). More preferably, the molten salt comprises a eutectic mixture of lithium carbonate, sodium carbonate and potassium carbonate.

Further it is preferred that the carbonate salt comprises from 20 to 60 mol. % lithium carbonate, preferably from 35 to 50 mol. %, based on the total amount of carbonate salts.

As mentioned above, the present invention aims to avoid the use of nitrate salts in the molten salt. To this end, it is preferred that the molten salt comprises at most 5.0 mol. % nitrate salt, preferably at most 1.0 mol. %, more preferably at most 0.1 mol. %, based on the total amount of the molten salt. Preferably, the molten salt comprises no nitrate salt at all.

Similarly, it is preferred according to the present invention to avoid the use of sodium and potassium chloride (NaCl and KCl) salts. To this end, it is preferred that the molten salt comprises at most 5.0 mol. % NaCl and/or KCl salt, preferably at most 1.0 mol. %, more preferably at most 0.1 mol. %, based on the total amount of the molten salt. Preferably, the molten salt comprises no NaCl and/or KCl salt at all.

Furthermore, it is preferred to avoid the use of ‘two valence’ carbonate salts (such as Mg (CO₃)) as these are thermally less stable. Hence, it is preferred that the molten salt comprises at most 5.0 mol. %, preferably at most 1.0 mol. %, more preferably at most 0.1 mol. % of such ‘two valence’ salts, based on the total amount of the molten salt. Preferably, the molten salt comprises no ‘two valence’ salts at all.

According to a preferred embodiment of the present invention, the molten salt (or mixture thereof) has a melting point of at most 540 °C, preferably at most 500 °C, more preferably at most 450 °C, even more preferably at most 410 °C. Usually, a molten salt comprising lithium carbonate has a melting point of above 397 °C.

According to an especially preferred embodiment according to the present invention, during the RWGS reaction in step b) the molten salt is purged with a CO₂-containing gas, preferably with a flux of at least 0.01 g/h/t (gram per hour per ton (1000 kg) ) carbonates in the RWGS reactor. This CO₂-purge may comprise simple ‘blanketing’ and/or a CO₂ dispersion method. By using a CO₂-purge, the reaction of any diffused hydrogen with molten carbonate salts (as described above) can be mitigated as any formed oxides are then converted back into the corresponding carbonates, thereby avoiding the build-up of insoluble oxides.

Usually, the CO₂-containing gas used as the CO₂-purge comprises at least 95 vol. % CO₂, preferably at least 99 vol. %.

As a result of the RWGS reaction in step b), a syngas containing stream is obtained, at least comprising hydrogen (H₂) and carbon monoxide (CO). Typically, the syngas containing stream also contains water (H₂O) and unconverted carbon dioxide (CO₂). Typically, the amounts of components in the syngas containing stream are around thermodynamic equilibrium concentrations of the RWGS reaction.

Generally, the syngas containing stream has a hydrogen to carbon monoxide (H₂/CO) volume ratio in the range of 1.5 to 10, preferably below 5.0, more preferably below 2.5.

One of the advantages of the present invention is that the used RWGS reaction results in low methanation (methane formation). Preferably, the syngas containing stream comprises at most 1.0 vol. % methane (CH₄), preferably at most 0.1 vol. % methane.

Preferably, the temperature of the syngas containing stream obtained in step b) (at the outlet of the RWGS reactor) is kept below 700 °C, preferably below 650 °C, more preferably below 600 °C and typically above 450 °C.

The person skilled in the art will readily understand that the syngas containing stream obtained in step b) can be further processed dependent on its intended further use, e.g. for the production of methanol or DME or for use in Fischer-Tropsch reactions.

In a further aspect, the present invention provides an apparatus suitable for performing the method for producing syngas according to the present invention, the apparatus at least comprising a RWGS reactor for subjecting a feed stream comprising at least hydrogen (H₂) and carbon dioxide (CO₂) to a catalytic RWGS reaction to obtain a syngas containing stream;

wherein the RWGS reactor comprises a multi-tubular reactor which during use can be heated by molten salt circulating around the tubes of the multi-tubular reactor, preferably in counter-current operation; and

wherein the molten salt comprises a carbonate salt.

Hereinafter the present invention will be further illustrated by the following non-limiting drawings.

Herein shows:

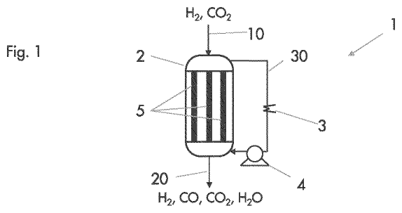

FIG. 1 schematically an apparatus suitable for performing the method for producing syngas using a catalytic RWGS reaction according to the present invention.

For the purpose of this description, same reference numbers refer to same or similar components.

The apparatus of FIG. 1, generally referred to with reference number 1, comprises a multi-tubular RWGS reactor 2, an external heater 3 and a pump 4.

The apparatus 1 will typically form part of a bigger process line-up (not shown) comprising e.g. heat exchangers, gas/liquid separators (e.g. in the form of a H₂O knock-out drum) and CO₂ removal units.

The multi-tubular RWGS reactor 2 comprises a plurality of tubes 5 heated by a molten salt circulating around the tubes 5 of the multi-tubular reactor 2. Each of the tubes 5 comprises a catalyst (not shown).

Preferably, the molten salt flow inside the shell of the multi-tubular reactor 3 is counter-currently when compared to the flow of the gas inside the tubes 5. In the embodiment of FIG. 1, the molten salt is fed near the bottom of the reactor 2, flows around the plurality of tubes 5 to the top of the reactor 2 and is then recirculated via molten salt recycle line 30.

As shown, the molten salt may be heated by external heater 3, preferably an e-heater, in the recycle line 30. During use, a feed stream 10 is provided, which comprises at least hydrogen (H₂) and carbon dioxide (CO₂).

The feed stream 10 is introduced into the multi-tubular RWGS reactor 2 and subjected to a catalytic RWGS reaction in the plurality of tubes 5, thereby obtaining a syngas containing stream, which is removed as stream 20 from the RWGS reactor 2.

The syngas containing stream 20 may be subjected to further process steps (not shown), including one or more further RWGS reaction steps.

### DISCUSSION

The method according to the present invention allows for an effective and safe way of producing syngas using a catalytic RWGS reaction, whilst the avoiding troublesome decomposition products formation (such as NOₓ) or severe safety issues when a nitrate salt would be used as a molten salt in a multi-tubular reactor (where inevitably some H₂ would diffuse from within the tubes of the multi-tubular reactor to the molten salt surrounding the tubes).

The person skilled in the art will readily understand that many modifications may be made without departing from the scope of the invention.

1. A method for producing syngas using a catalytic reverse water gas shift (RWGS) reaction, the method at least comprising the steps of:
a) providing a feed stream (10) comprising at least hydrogen (H₂) and carbon dioxide (CO₂);
b) introducing the feed stream (10) provided in step a) into a RWGS reactor (2) and subjecting it to a catalytic RWGS reaction, thereby obtaining a syngas containing stream (20);
wherein the RWGS reactor (2) comprises a multi-tubular reactor heated by molten salt circulating around the tubes (5) of the multi-tubular reactor, preferably in counter-current operation;
wherein the molten salt comprises a carbonate salt; and
wherein during the RWGS reaction in step b) the molten salt is purged with a CO₂-containing gas, preferably with a flux of at least 0.01 g/h/t (gram per hour per ton (1000 kg)) carbonates in the RWGS reactor (2).

2. The method according to claim 1, wherein the RWGS reactor (2) comprises a catalyst comprising at least cerium oxide, zirconium oxide or a combination thereof.

3. The method according to claim 1, wherein the molten salt comprises at least 90 wt. % carbonate salt, based on the total weight of the molten salt.

4. The method according to claim 1, wherein the carbonate salt is selected from the group consisting of sodium carbonate, lithium carbonate and potassium carbonate and mixtures thereof.

5. The method according to claim 4, wherein the carbonate salt comprises from 20 to 60 mol. % lithium carbonate.

6. The method according to claim 1, wherein the molten salt comprises at most 5.0 mol. % nitrate salt. based on the total amount of the molten salt.

7. The method according to claim 1, wherein the molten salt has a melting point of at most 540 °C.

8. The method according to claim 1, wherein the syngas containing stream (20) obtained in step b) comprises at most 1.0 vol. % methane (CH₄).

9. The method according to claim 1, wherein the temperature of the syngas containing stream (20) obtained in step b) is kept below 700 °C.

10. An apparatus (1) suitable for performing the method for producing syngas according to claim 1, the apparatus (1) at least comprising a RWGS reactor (2) for subjecting a feed stream (10) comprising at least hydrogen (H₂) and carbon dioxide (CO₂) to a catalytic RWGS reaction to obtain a syngas containing stream (20);
wherein the RWGS reactor (2) comprises a multi-tubular reactor which during use can be heated by molten salt circulating around the tubes (5) of the multi-tubular reactor, preferably in counter-current operation; and
wherein the molten salt comprises a carbonate salt.
